(19) United States
(12) Patent Application Publication
(10) Pub. No.: US 2014/0360326 A1
(43) Pub. Date: Dec. 11, 2014

(54) CUP CUTTER AND METHOD

(71) Applicant: J.R. Simplot Company, Boise, ID (US)

(72) Inventors: David Bruce Walker, Meridian, ID (US); Allen J. Neel, Nampa, ID (US)

(73) Assignee: J.R. Simplot Company

(21) Appl. No.: 14/297,033

(22) Filed: Jun. 5, 2014

Related U.S. Application Data
(60) Provisional application No. 61/832,554, filed on Jun. 7, 2013.

(51) Int. Cl. B26D 3/26; B26D 1/00; B26D 7/06; B26D 3/10

(52) U.S. Cl. CPC B26D 3/26; B26D 3/10; B26D 1/0006; B26D 7/0658; B26D 2001/006; B26D 2001/0066
USPC 83/48; 83/673; 83/401; 83/402

(57) ABSTRACT

A cutting head for a food product cutting system includes a generally cylindrical rotatable body, having a radius and configured to rotate about an axis, and a plurality of spatially separated, generally parallel elongate cutting blades, arranged in a circular array centered on the axis and defining a perimeter of the body. Each blade has a long dimension and an outwardly-oriented cutting edge. The generally cylindrical rotatable body is connectable to a driving mechanism configured to rotate the cutting head about the axis, and is positionable adjacent to a food product delivery mechanism, whereby food product that contacts the cutting edges of the array of blades in a direction generally perpendicular to the axis is cut by the blades into slices having a repeatable curvature.

### PRIORITY CLAIM

The present application claims the benefit of U.S. Provisional Application Ser. No. 61/832,554, filed on Jun. 7, 2013 and entitled CUP CUTTER, the disclosure of which is incorporated herein by reference in its entirety.

### BACKGROUND

1. Field of the Invention

The present invention relates generally to systems and methods for cutting food products. More particularly, the present invention relates to a cutter for food items that is capable of producing slices and chips with compound curves.

2. Related Art

There are a variety of devices and methods for cutting food products, such as root vegetables and the like, into various shapes. For example, known potato slicers, such as the Urschel OV and Translicer, can produce flat or crinkled slices using a cutting wheel that is fundamentally planar. Other devices for producing ridged shapes, waffle cuts and spiral shaped potato slices and the like are also known.

These known cutters are not believed to be capable of controllably producing slices and chips with compound curves, and such products do not appear to be known. Instead, producers of food products that have compound curves rely upon methods that either produce irregular results, or methods that are complicated, time-consuming and/or expensive to implement. For example, various types of chips and the like use forms to create a desired shape from a generally flat portion of dough or the like. A well-known brand of uniformly-curved potato chips are also shaped using forms. The use of forms tends to be slow and relatively expensive.

On the other hand, there are many food products that have compound curves, but the exact shape and configuration of these curves is a random result of the manufacturing process. For example, corn chips and tortilla chips frequently present compound curved shapes, but these shapes are random, as are the shapes of potato chips generally. It does not appear that there are systems and methods currently known that allow the controllable and selective cutting of food products into slices and chips with compound curves that are highly consistent and controllable.

The present application is directed to one or more of the above-mentioned issues.

### SUMMARY

It has been recognized that it would be advantageous to develop a cutter that is capable of producing slices and chips with compound curves, the configuration of the curves being consistent and controllable.

It has also been recognized that it would be advantageous to have a cutter that is capable of producing slices and chips with compound curves, and which is simple to operate and maintain.

It has also been recognized that it would be advantageous to have a cutter that is capable of producing slices and chips with compound curves that has a high throughput and relatively low cost to operate.

In accordance with one embodiment thereof, the present invention provides a cutting head for a food product cutting system, including a generally cylindrical rotatable body, having a radius and configured to rotate about an axis, and a plurality of spatially separated, generally parallel elongate cutting blades, arranged in a circular array centered on the axis and defining a perimeter of the body. Each blade has a long dimension and an outwardly-oriented cutting edge. The generally cylindrical rotatable body is connectable to a driving mechanism configured to rotate the cutting head about the axis, and is positionable adjacent to a food product delivery mechanism, whereby food product that contacts the cutting edges of the array of blades in a direction generally perpendicular to the axis is cut by the blades into slices having a repeatable curvature.

In accordance with another aspect thereof, the invention provides a food product cutting system, including a motor, having a rotatable drive shaft downwardly oriented along a substantially vertical axis, a generally cylindrical cutting head, attached at a distal end of the drive shaft, and a food product delivery device. The cutting head has a radius and includes a plurality of generally upright blades, symmetrically disposed about the vertical axis and having outwardly-oriented cutting edges, the blades defining an inside and an outside of the drum and a lower discharge opening. The food product delivery device is configured to advance food product laterally against the blades of the rotating cutting head, whereby the product is cut into slices having a repeatable curvature, the slices dropping through the discharge opening after cutting.

In accordance with yet another aspect thereof, the invention provides a method for cutting a food product. The method includes rotating a generally cylindrical cutting head about an axis, and advancing a food product against the rotating cutting head in a direction generally perpendicular to the axis. The cutting head has a radius and an array of blades spatially separated blades symmetrically disposed about the axis, the blades having outwardly-oriented cutting edges. Advancing a food product against the rotating cutting head causes the food product to be cut by the blades into slices having a repeatable curvature.

### BRIEF DESCRIPTION OF THE DRAWINGS

Additional features and advantages of the invention will be apparent from the detailed description which follows, taken in conjunction with the accompanying drawings, which together illustrate, by way of example, features of the invention, and wherein:

FIG. 1 is a front view of a cup cutting machine configured for controllably and repeatably slicing food products into shapes having compound curves;

FIG. 2 is a perspective view of the cup cutting machine of FIG. 1;

FIGS. 3A-3D are perspective, front, front cross-sectional and bottom views, respectively, of a cylindrical cutting head for use in the cup cutting device of FIGS. 1 and 2, which is configured to produce cut slices that are generally barrel shaped;

FIG. 4 is a perspective view of a barrel-shaped cut slice produced using a cylindrical cutting head like that shown in FIGS. 3A-3D;

FIGS. 5A-5D are perspective, front, front cross-sectional and bottom views, respectively, of a truncated spherical cutting head for use in the cup cutting device of FIGS. 1 and 2, which is configured to produce spherically curved cut slices;

FIG. 6 is a perspective view of a spherically curved cut slice that has been produced using a truncated spherical cutting head like that shown in FIGS. 5A-5D;

FIGS. 7A-7D are perspective, front, front cross-sectional and bottom views, respectively, of a frusto-conical cutting head for use in the cup cutting device of FIGS. 1 and 2, which is configured to produce conically curved cut slices;

FIG. 8 is a perspective view of a conically curved cut slice produced using a frusto-conical cutting head like that shown in FIGS. 7A-7D;

FIG. 9 is a cross-sectional view of a portion of a cutting blade that has a corrugated pattern for cutting ridged shapes.

FIG. 10 is a schematic diagram of an embodiment of a food product cutting system that includes multiple slicing machines in parallel, including a cup cutter;

FIG. 11 is a schematic diagram of an embodiment of a food product cutting system that can selectively employ multiple slicing machines, including a cup cutter, which are mounted upon a track system; and

FIG. 12 is a schematic diagram of a system for selectively employing multiple cup cutting or other food product cutting machines in parallel by selective adjustment of valves in a water transport system.

### DETAILED DESCRIPTION

Reference will now be made to exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

As noted above, known devices and methods for cutting food products can produce flat or crinkled slices using a cutting wheel that is fundamentally planar. However, known food cutting machines do not appear to be capable of controllably producing slices and chips with compound curves. Advantageously, the present disclosure provides a system for cutting food products that can produce a family of new cut shapes. This cutting system can be used for cutting a variety of vegetables and other food products, and applications in other industries may also exist. One useful application is in cutting new potato chip shapes.

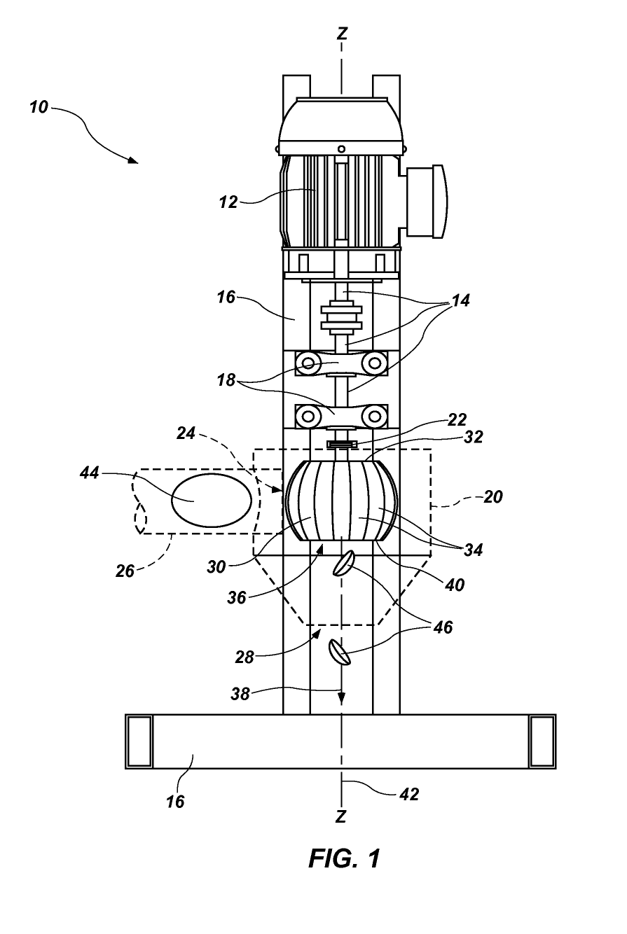

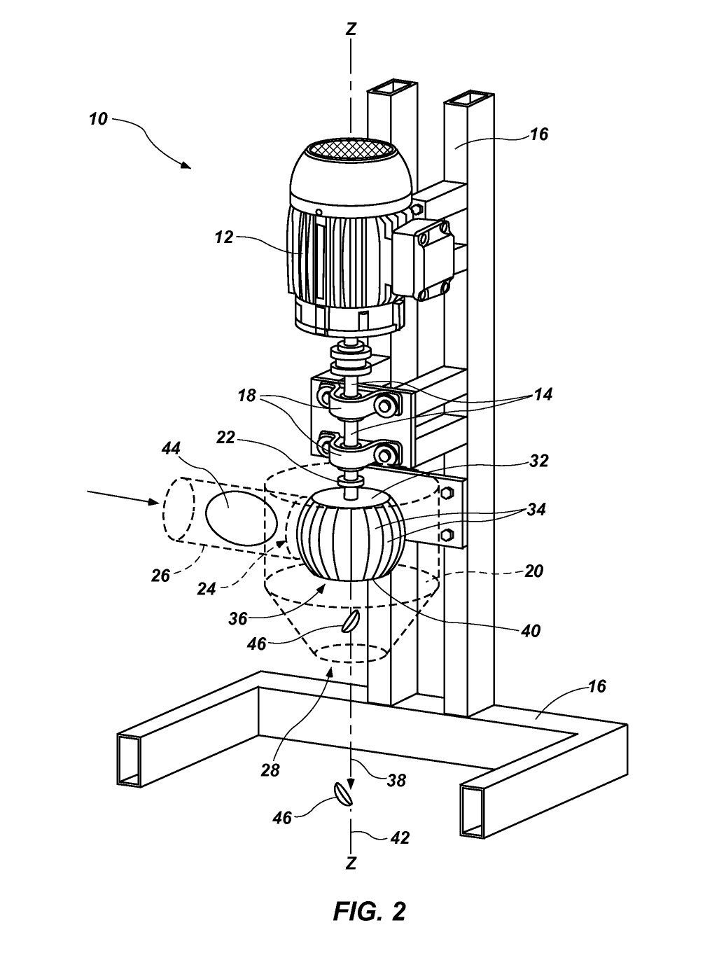

Shown in FIG. 1 is a front view of a cup cutting machine 10 configured for controllably and repeatably slicing food products into shapes having compound curves. Provided in FIG. 2 is a perspective view of the same machine 10. The cup cutting machine 10 generally includes a motor 12 that is vertically oriented, with a motor shaft 14 that extends downward from the motor 12. The motor 12 is attached to a frame 16 that supports it, and a pair of bearings 18 are also attached to the frame 16 and support the rotating shaft 14.

The motor shaft 14 extends into a containment housing 20 through a seal 22 in the top of the housing 20. The housing 20 includes a side entry point 24 that communicates with a product delivery device, which in this case is a product transport conduit 26 of a water knife pump system, and a bottom discharge opening 28. Other product delivery devices can also be used, such as mechanical feed systems. Inside the housing 20 is a generally cylindrical cutting head 30, which is attached to the motor shaft 14 and positioned adjacent to the outlet 24 of the product transport conduit 26. The cutting head 30 has a top plate or upper hub 32, which attaches to the motor shaft 14, and a plurality of cutting blades 34 that extend downward from the top plate 32 in a generally cylindrical array, defining an interior region of the cutting head 30. The lower ends of the cutting blades 34 define a generally circular discharge opening 36 for the cut product to drop through and exit the machine after cutting, as indicated by the arrow 38. The bottom ends of the blades 34 of the cutting head 30 are connected to an annular lower hub or rim 40, which has a relatively large central aperture that defines the circular discharge opening 36.

The blades 34 have outwardly-oriented cutting edges. When rotated by the motor shaft 14, the cutting head 30 rotates about a vertical axis 42, labeled as the z axis in FIGS. 1 and 2, while individual units of food product 44 (e.g. potatoes) are sequentially pushed against the outside of the cutting head 30, generally perpendicular to the vertical axis 42, against the array of moving blades 34. The rotating cutting head 30 cuts slices 46 from the food product 44, which drop through the discharge opening 26 of the cutter head 30 and thence through the discharge opening 28 of the housing 20, as indicated by arrow 38. A jet (not shown) of air, water or other fluid can be positioned inside the containment housing 20 or inside the cutting head 30 to assist in pushing the slices through the discharge openings 28, 38 by driving the cut product 46 downward and out of the cutting head.

While in the embodiment shown in FIGS. 1 and 2 the motor 12 and its shaft 14 are vertically oriented, other orientations are also possible for the axis of rotation 42, including horizontal, for example. Rotation about a vertical axis is believed to be advantageous, however, because gravity can help carry the cut slices out of the cutting head 30 in this orientation.

Because of the exterior curvature and rotation of the cutting head 30, and the speed of advancement of the food product 44 against the cutting head 30, the cut slices 46 will have a distinct curvature, which can be a single curvature or compound curvature of various shapes, depending on the shape or profile of the cutting blades 34. The blades 34 can have a very particular shape to allow the uncut food product 44 to advance at uniform speed while the cutting occurs. Many blade profiles and consequent product shapes are possible.

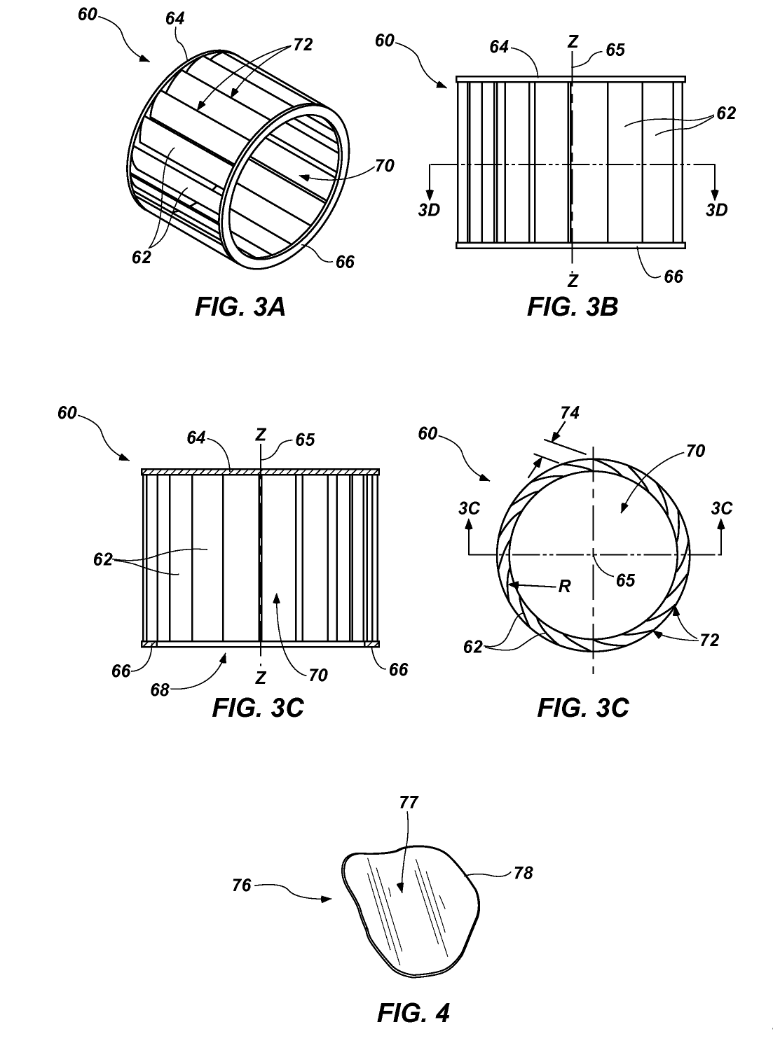

Referring to FIGS. 3A-3D, the simplest configuration of a cutting head that can be used in accordance with the present disclosure is a cylindrical cutting head 60 with straight blades 62, which looks similar to a squirrel cage fan. This cutting head 60 can cut slices that are cylindrical sections of single curvature—i.e. having a barrel shape, as shown in FIG. 4.

The cylindrical cutting head 60 shown in FIGS. 3A-3D generally includes a top plate 64, a plurality of vertically straight blades 62 that depend from the top plate 64 and are disposed in a circular array oriented around the rotational or z axis of the cutting head 60, indicated at 65 in FIG. 3D (representing the z axis 42 in FIGS. 1, 2). The cutting head 60 also includes a bottom rim 66 that interconnects all of the blades 62 and defines a central discharge opening 68. The top plate 64 is connectable to the shaft (14 in FIGS. 1, 2) of the drive motor (12 in FIGS. 1, 2) by bolts, screws or any other suitable attachment mechanism (not shown), and the discharge opening 68 allows cut product (46 in FIGS. 1, 2) to drop from the interior 70 of the cutting head 60 after it has been cut.

When the cylindrical cutting head 60 is attached to the vertical drive shaft (14 in FIG. 1, 2), the blades 62 are vertically oriented, with the cutting edges 72 of the blades facing outward relative to the overall shape of the cutting head 60. The individual blades 62 can each have a slight curvature about a vertical axis, indicated by “R” in FIG. 3D. This curvature can be approximately equal to the overall diameter of the cutting head 60, so that the trailing portion of the blade 62 follows the curved path of the blade tip 72 through the food product as it cuts, thereby reducing friction and resistance to cutting. More particularly, the trailing edge of the blade 62 follows the cutting edge 72 of the blade through the food product when the forward velocity of the product (44 in FIG. 1) is accounted for. The radius of curvature of the blade 62 about the z axis decreases slightly from the cutting edge 72 to the trailing edge to allow the product to proceed forward with uniform velocity. This characteristic of blade geometry can be applied to all of the cutting blade configurations disclosed herein. The blades 62 also have a space 74 between them, which is at least as large as the thickness of the cut slices (76 in FIG. 4). The thickness of the cut slices depends on the dimension of this space as well as the feed rate of the food product to the cutting head.

The cut slice that is formed by the cutting head in FIGS. 3A-3D will have a single-curved surface, and will be substantially barrel shaped, as shown in FIG. 4. This figure shows a potato slice 76 that has been cut with a cup cutter having a cylindrical cutting head like that of FIGS. 3A-3D. This slice has a central arched region 77, the curvature of which depends upon the radius of the cutting head 60, with edges 78 having a shape that depends on the shape and size of the food product from which it was cut, and the orientation of the food product at the moment that it contacted the cutting head 60 and was cut. The slice 76 has an outline that is similar to existing potato slices or chips, but is a section of a cylinder of the same radius as the cutting head 60.

The blade shapes for the various cutting head embodiments shown herein can be mathematically defined using polar and cylindrical coordinate systems. In defining the shape of the blades, the origin is set in the geometric center of the cutting head (e.g. point 65 in FIG. 3D), with the z axis of the coordinate system being set collinear with the motor shaft (14 in FIGS. 1, 2) and the axis of rotation (42 in FIGS. 1, 2) of the cutting head (30 in FIGS. 1, 2). It is also to be understood that the origin point 65 is located midway between the planes of the top plate 64 and the bottom rim 66, approximately aligned with the section line 3D in FIG. 3B. In the following mathematical discussion the variable r is the distance from the z axis, while 0 represents the angle of a line starting at the origin (e.g. point 65 in FIG. 3D) and pointing into the product flow (e.g. conduit 26 in FIGS. 1, 2).

In the following expression for the surface of a blade, R is the radius of the cutting head (and the radius of the cut slices), N is the number of blades in the cutting head, and T is the cut thickness. Expressing the θ coordinate in degrees and using any consistent length unit for r and z, the two length dimensions, the expression for the shape of the blade surface 62 is:

r(θ,z)=R−(NTθ)/360 [1]

For a cylindrical cutting head 60 having straight blades 62 like that shown in FIGS. 3A-3D, r (θ, z) does not vary with z, and z does not appear in the expression. In other words, the surface shape of the blade is the same for all values of z, and the blade will produce a cylindrical cut piece 76, as shown in FIG. 4. Technically speaking, this piece 76 has the shape of a portion of a hollow cylinder.

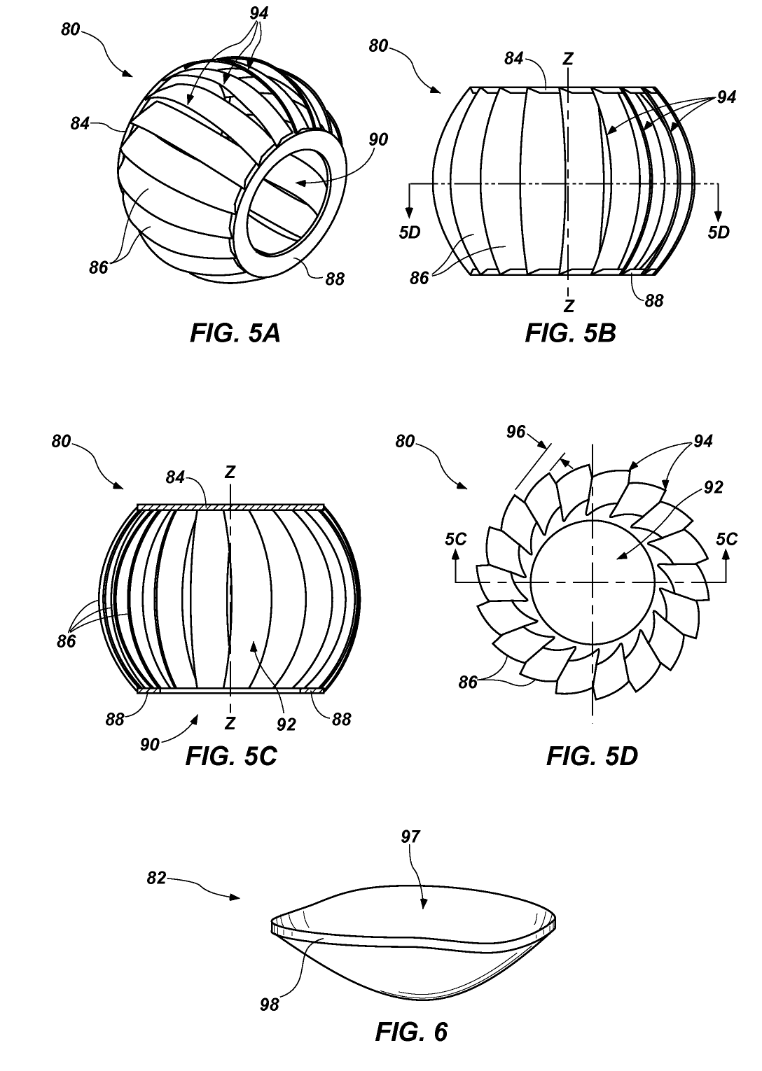

Other cut shapes result when r does vary with z, and varying these parameters allows the creation of cut slices with compound curves. Many functional forms can be superimposed upon the basic expression above to describe blade surface shapes to create many slices of differing shapes. One such possibility is to vary r with z such that a spherically-curved surface is cut. Provided in FIGS. 5A-5D are perspective, front, front cross-sectional and bottom views, respectively, of a truncated spherical cutting head 80 for use in the cup cutting device 10 of FIGS. 1 and 2. Provided in FIG. 6 is a perspective view of a spherically curved cut slice 82 that has been produced using a truncated spherical cutting head 80 like that shown in FIGS. 5A-5D.

The truncated spherical cutting head 80 has the general shape of a symmetrical segment of a sphere, with top and bottom planes where opposing “caps” of a truly spherical shape would normally be. This cutting head 80 generally includes a top plate 84, a plurality of outwardly curved blades 86 that depend from the top plate 84 in a circular array, and a bottom rim 88 that interconnects all of the blades 86 and defines a central discharge opening 90. The outward curvature of the blades 86 is referred to herein as curvature about a transverse axis, meaning an axis that is perpendicular to the z axis. The top plate 84 is connectable to the shaft (14 in FIGS. 1, 2) of the drive motor (12 in FIGS. 1, 2), while the discharge opening 90 allows cut product 82 to drop from the interior 92 of the cutting head 80 after it has been cut. While this cutting head 80 has curved blades 86, for purposes of this discussion it is still considered generally cylindrical, and rotates about the z axis.

When the truncated spherical cutting head 80 is attached to the vertical drive shaft (14 in FIGS. 1, 2), the blades 86 are generally vertically oriented, with the curved cutting edges 94 of the blades 86 facing outward relative to the overall shape of the cutting head 80. The radius of curvature of the blades 86 about the transverse axis can be approximately equal to the overall radius of the cutting head 80, thus producing the truncated spherical shape of the cutting head 80. It will be apparent, however, that this radius will not be equal to the radius of the top plate 84 or lower rim 88, since these features represent non-diametrical sections of the overall spherical shape. It is also to be appreciated that, while the cutting head shape shown in FIGS. 5A-5D is a truncated sphere, other similar shapes can also be used for creating compound curved cut slices. For example, cutting blades having a varying radius of curvature, or that define a cutting head having a truncated ellipsoidal shape, etc. can also be used.

The individual blades 86 can each have a slight curvature about their long axis, as discussed above with respect to the straight blades (62 in FIGS. 3A-D) in the cylindrical cutting head (60 in FIGS. 3A-D). This curvature is indicated at “R” in the view of FIG. 5D. Again, this curvature can be approximately equal to the overall radius of the cutting head 80, so that the trailing portion of the blade 86 follows the curved path of the blade tip through the food product as it cuts. This radius R can also diminish toward the trailing end of the blade 86 to accommodate the speed of advancement of the food product, as discussed above The curved cutting blades 86 also have a space 96 between them. The thickness of the cut slices 82 depends on the dimension of this space 96 as well as the feed rate of the food product to the cutting head 80.

The cut slice 82 that is formed by the cutting head in FIGS. 5A-5D will have a double-curved surface, and will be substantially cup shaped, as shown in FIG. 6. This figure shows a potato slice 82 that has been cut with a cup cutter having a truncated spherical cutting head 80 like that of FIGS. 5A-5D. This slice 82 has the general shape of a segment of a hollow sphere, with a central spherically curved region 97, and edges 98 that define a generally circular shape. The curvature of the central region 97 is defined by the curved cutting blades 86, while the actual shape of the edge 98 depends on the shape and size of the food product from which it was formed, and the orientation of the food product at the moment that it contacted the cutting head and was cut. It will be appreciated that a food item of irregular shape can produce a cut slice having an irregular edge shape.

Using the variables presented in equation [1] above, a mathematical expression for the surface of the curved blade 86 of the truncated spherical cutting head 80 is:

r(θ,z)=(R²−z²)^{0.5}−(NTθ)/360 [2]

As shown in this equation, this blade shape produces slices of thickness T that are sections of spheres of radius R.

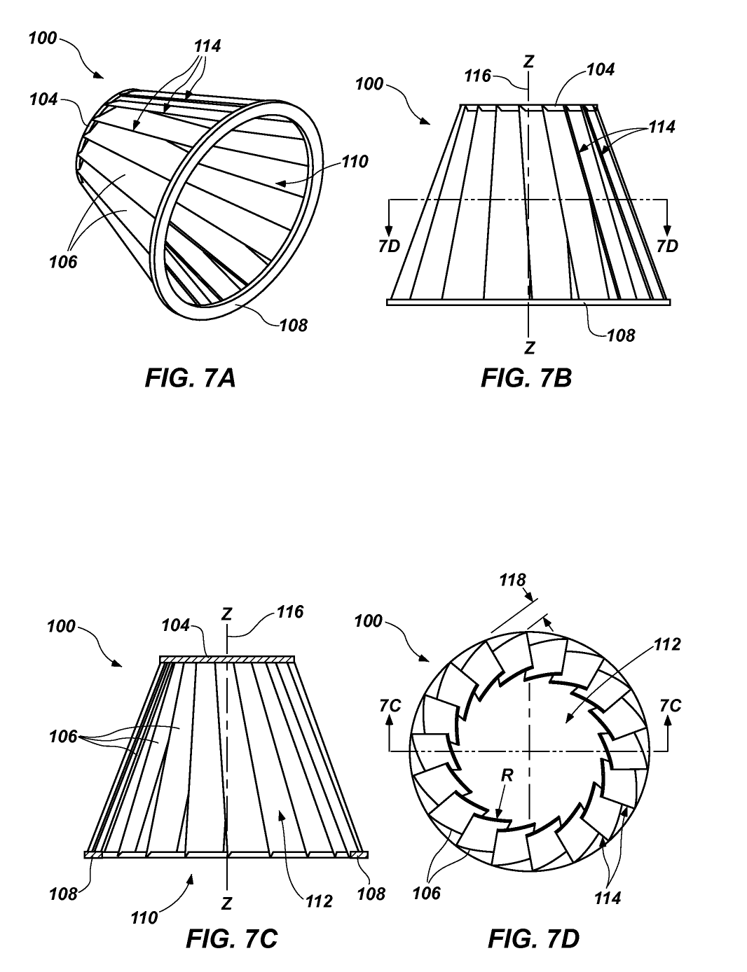

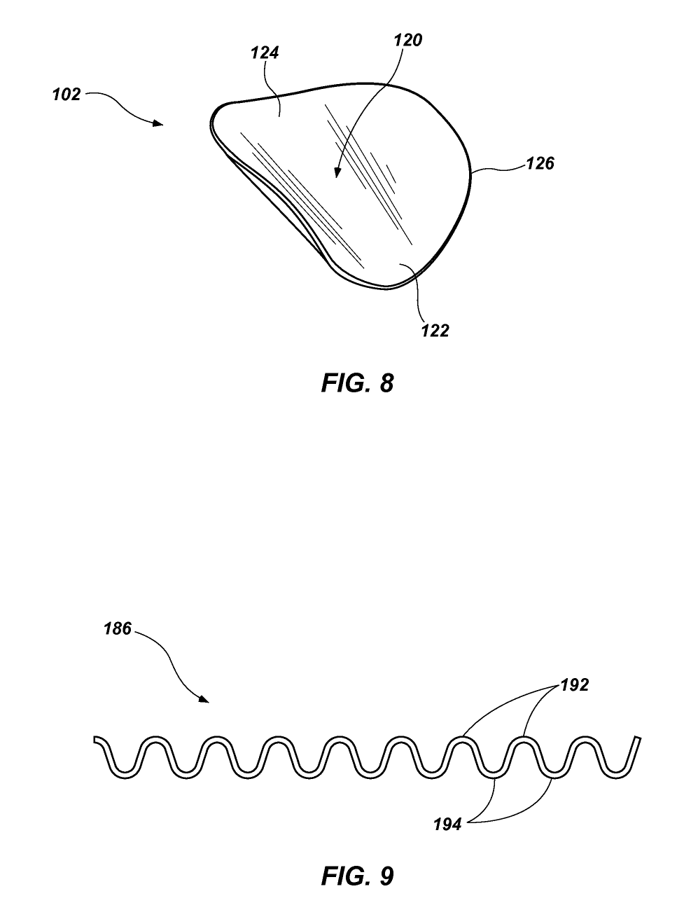

Many other possibilities for blade shapes exist, and an ideal blade surface shape can be generated by superimposing any desired function of z on the basic expression of equation [2]. As another example, a frusto-conical cutting head 100 can be used, as illustrated in FIGS. 7A-7D. FIGS. 7A-7D are perspective, front, front cross-sectional and bottom views, respectively, of a frusto-conical cutting head 100 for use in the cup cutting device 10 of FIGS. 1 and 2, which is configured to produce semi-conical cut slices 102, shown in FIG. 8. The frusto-conical cutting head 100 generally includes a top plate 104, a plurality of straight blades 106 that depend from the top plate 104 in a conical array, and a bottom rim 108 that interconnects all of the blades 106 and defines a central discharge opening 110. The top plate 104 is connectable to the shaft (14 in FIGS. 1, 2) of the drive motor (12 in FIGS. 1, 2), while the discharge opening 110 allows cut product 102 to drop from the interior 112 of the cutting head 100 after it has been cut. While this cutting head 100 has a tapered conical shape, for purposes of this discussion it is still considered generally cylindrical, and rotates about the z axis.

When the frusto-conical cutting head 100 is attached to the vertical drive shaft (14 in FIGS. 1, 2), the blades 106 are downwardly oriented in a conically flared array, with the cutting edges 114 of the blades 106 facing outward relative to the overall shape of the cutting head 100. The individual blades 106 can each have a slight curvature about a vertical axis, as indicated by “R” in FIG. 7D. As discussed above, this curvature can be approximately equal to the overall diameter of the cutting head 100, so that the trailing portion of the blade 106 follows the curved path of the blade tip 114 through the food product as it cuts. Since the overall diameter of the conical cutting head 100 varies relative to the vertical axis, indicated at 116, the radius of curvature R of the blades can also vary, and can also diminish toward the trailing end of the blade to accommodate the speed of advancement of the food product, as discussed above. As with the other embodiments discussed above, the blades 106 have a space 118, shown in FIG. 7D, between them, and the thickness of the cut slices depends on the dimension of this space 118 as well as the feed rate of the food product to the cutting head 100.

The cut slice 102 that is formed by the cutting head 100 in FIGS. 7A-7D will have a single-curved surface, and will be semi-conically shaped, as shown in FIG. 8. This figure shows a potato slice 102 that has been cut with a cup cutter having a conical cutting head 100 like that of FIGS. 7A-7D. This slice 102 has the shape of a section of a hollow cone, with a central arched region 120 having a radius of curvature that varies in a generally linear fashion from a first end 122 to a second end 124 of the slice 102. The curvature of the central region 120 is defined by the radius of the cutting head 100 at a given position relative to the z axis. The edges 126 of the slice 102 have a shape that depends on the shape and size of the food product from which it was formed, and the orientation of the food product at the moment that it contacted the cutting head 100 and was cut. Once again, the slice 102 has an outline that is similar to existing potato slices or chips, but is a section of a hollow cone having dimensional characteristics like those of the cutting head 100.

With any of the cutting heads shown herein, the product velocity through the cutting head is a simple function of cutter RPM and the parameters listed above.

Product velocity (length/minute)=RPM×T×N [4]

In this equation T is the slice thickness, and N is the number of blades on the cutting head. Suitable values for these parameters can vary. Faster product velocity will increase throughput, so higher RPM, greater cut thickness, and a larger number of blades will all increase throughput. RPM can be limited by the mechanical strength of the cutting head and the bearing system. Cut thickness T will depend on the product characteristics desired—e. g. potato chip, potato slice, etc. The number of blades N can be limited by cut thickness T and the minimum r(theta,z) for the particular blade's profile. Naturally, it is desirable that the blades fit the hubs (i.e. top plate and bottom tim) of the cutting head without interference. It is believed that one set of suitable values for RPM, T, and N would be around RPM=1000, T=0.3″, and N=12 blades in a hollow truncated spherical cutting head.

One feature that can be added to any of the cutter head configurations shown and described herein is the addition of ridges or corrugations to the cutting blades, in order to produce a ridged or crinkled cut, if desired. Crinkles increase surface area for added crispness and potentially higher uptake of batter, seasoning, or oil. Potato chips or slices from this cutter can work very well for dipping or as bases for placing condiments. Shown in FIG. 9 is a cross-sectional view of a cutting edge portion 186 of a cutting blade that has a corrugated pattern for cutting slices with crinkles. This figure shows the cutting edge 186 in end elevation to show a series of corrugations that include a series of peaks 192 and valleys or troughs 194, to form a corresponding corrugated peak-trough cut in the food product slice.

In the various embodiments shown FIGS. 3-8, the multiple cutting blades of each cutting head can be identical. Alternatively, cutting head configurations with knives that are not all identical can also be used. For example, corrugated blades can alternate with non-corrugated blades in any cutting head in order to produce cut slices that are corrugated on one side and smooth on the other. Other alternatives can also be used.

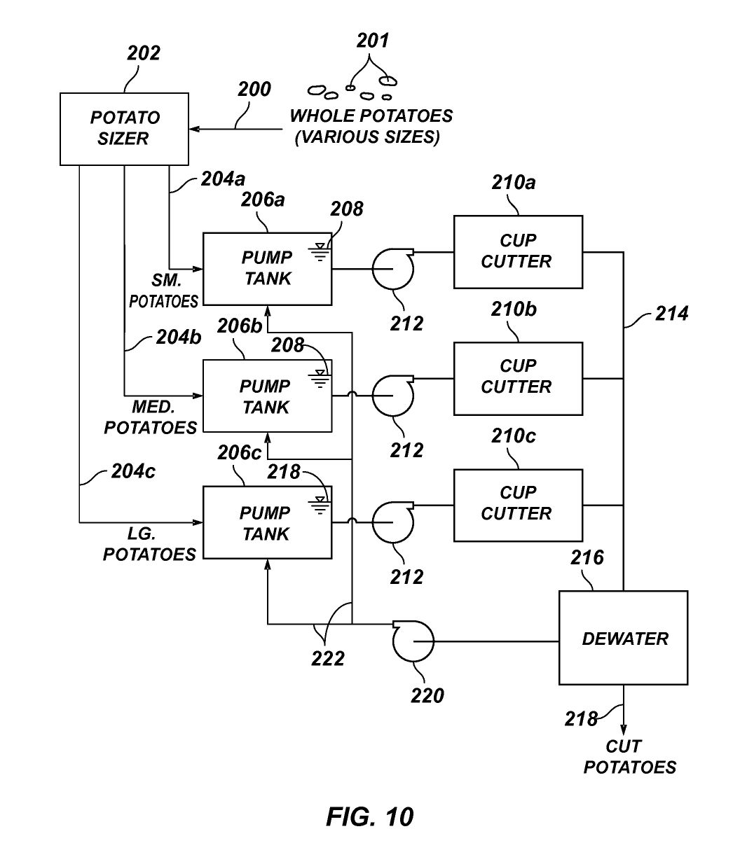

The cup cutting system and related elements depicted in FIGS. 1-9 and described above can be incorporated into various systems for transporting and controlling products to be cut. Several embodiments for such systems are shown in FIGS. 10-12. Each of these systems include a transport system that is configured for transporting food products in single file toward an outlet, and a plurality of cutting machines positioned at the outlet(s). These systems also include a selection device that is configured to selectively couple the outlet of the transport system to one or more of the cutting machines. Such systems can allow for easy variation of cutting methods, and/or for easier selection of system components and taking certain components off line for cleaning, maintenance, etc.

Shown in FIG. 10 is a diagram of a system for simultaneously employing multiple water knives in parallel for cutting potatoes. This system generally includes an input stream 200 of whole potatoes 201 of various sizes, which are first fed into a potato sizing machine 202, which segregates the potatoes 201 by size, and selectively discharges them into any one of multiple transport conduits 204a-c. The potato sizing machine 202 in this embodiment operates as a selection device. Each of the transport conduits 204 lead to a pump tank 206, which stores the potatoes 201 in a hydraulic fluid 208 (e.g. water) in preparation for feeding into the respective cup cutter 210. Each pump tank 206 is connected to a pump 212, which pumps the hydraulic fluid 208 with the potatoes 201 in single file, to a unique cup cutter 210. In a three machine cup cutter system, as shown, the potatoes 201 are sorted into small, medium and large sizes, and conveyed to three cup cutters 210 of different sizes. Three and four cutting machine systems are common, and other numbers of machines can be used.

The system of FIG. 10 also includes a collection system, disposed downstream of the cutting machines, configured to collect the slices after cutting. Specifically, following cutting by the respective cutting machines 210, the potatoes 201 enter a common collection flume 214 which leads to a dewatering machine 216. Those of skill in the art will be aware that food product collection systems often collect product on a conveyor belt, in a flume, or on a vibratory conveyor. Mesh belt conveyors, fixed screens, or vibratory conveyors are frequently used to dewater. The dewatering machine separates the hydraulic fluid (e.g. water) from the potato slices, and discharges the cut and dewatered potato slices in one stream 218 (e.g. on a conveyor belt or chain) and returns the water to the pump tanks 206 via a pump 220 and return water lines 222.

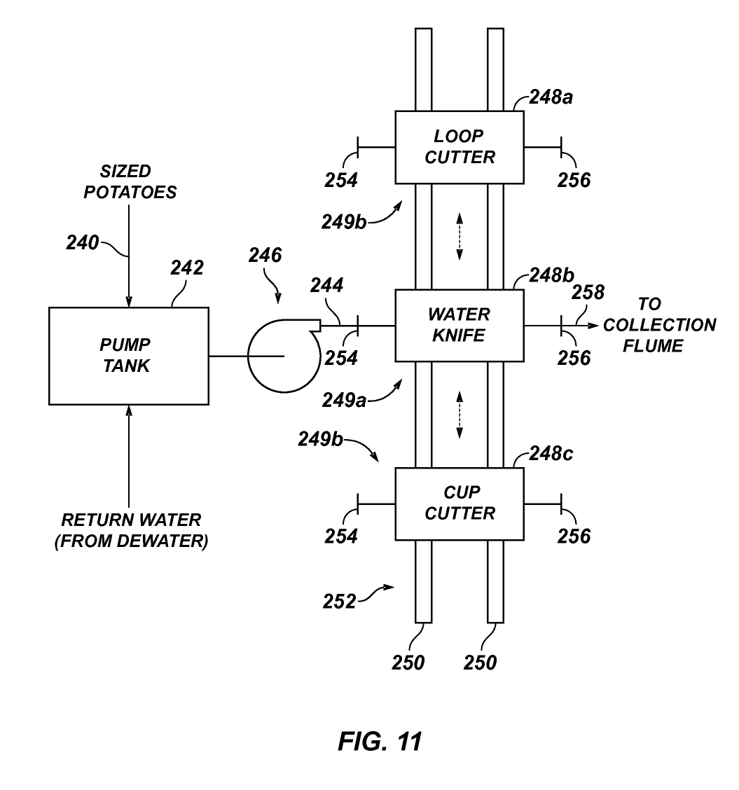

Shown in FIG. 11 is a diagram of another system for selectively employing multiple slicing machines, in which the selection device is a cutting machine transport device that selectively moves one of multiple cutting machines into an operating position. In this configuration, a stream 240 of sized potatoes is provided to a pump tank 242, then pumped toward an outlet 244 of the single transport system 246. Multiple slicing machines 248 are moveably mounted upon rails 250 of a track system 252. The track system 252 is the cutting machine transport device, upon which the plurality of cutting machines 248 are mounted. The system is configured to selectively move any one of the plurality of cutting machines 248 between an active position 249a in communication with the outlet 244 of the transport system 246, and one or more inactive positions, indicated at 249b.

Each cutting machine 248 includes a releasable coupler 254 at its inlet end, configured for selectively releasably connecting the respective cutting machine 248 to the outlet 244 of the transport system 246. Each cutting machine 248 also includes a releasable coupler 256 at its outlet end, configured for selectively releasably connecting the respective cutting machine 248 to the inlet of a collection system or collection flume 258, disposed downstream of the cutting machines 248. As discussed above, the collection system 258 is configured to collect the slices after cutting, and can lead to a dewatering system, etc.

In the system of FIG. 11 the cutter 248 that is desired for a particular product can be rolled into place upon the rails 250 and quickly connected to the transport system 246 and collection system 258 with the releasable couplings 254, 256. This configuration allows multiple types of cutting machines, such as loop and cup cutters, to be added to a water knife system via the track system 252. This can allow rapid selection and switching between the different types of machines, and can also make it easier to take one machine off line for cleaning or maintenance.

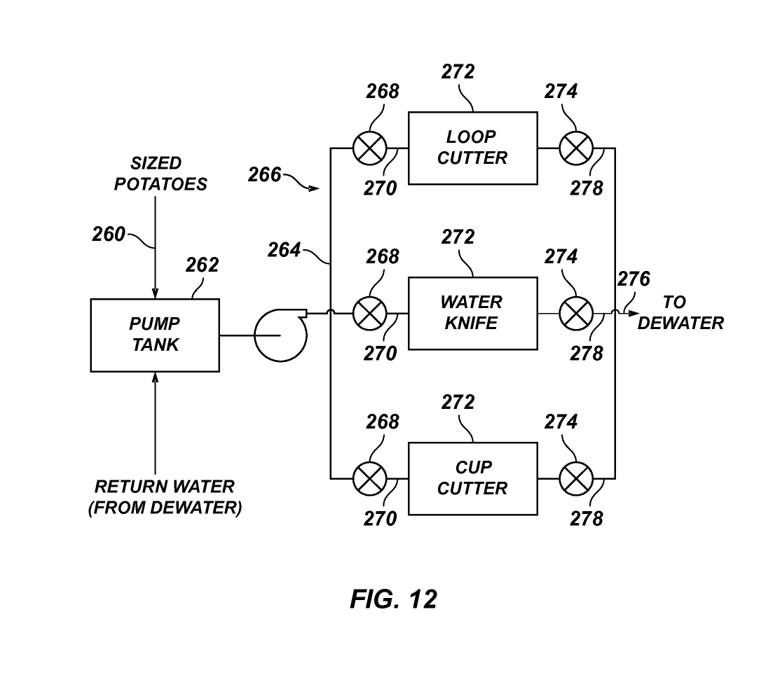

Another approach is shown in FIG. 12, which provides a diagram of a system for selectively employing multiple slicing machines in parallel via selective adjustment of valves in a water transport system. In this embodiment, a stream 260 of sized potatoes is provided to a pump tank 262, then pumped toward an outlet 264 of the single transport system 266. In this embodiment, rather than moving different cutting machines to an operating position, the cutters are stationary and product is directed to and from the desired cutter by opening or closing valves in a piping system. Specifically, the selection device in this system includes a plurality of transport valves 268, disposed in communication with the outlet 264 of the transport system 266, and a plurality of transport extensions 270, each extending from one of the plurality of transport valves 268 to one of the plurality of cutting machines 272. This arrangement can be used for selectively switching between the use of multiple cutting machines of different types. It could also be used for simultaneously employing multiple cutting machines of the same type at the same time. Other uses may also be possible.

The system shown in FIG. 12 also includes a plurality of collection valves 274, each disposed in a collection system 276 downstream of the cutting machines 272. A plurality of collection system extensions 278 extend from each one of the collection valves 274 to a common portion of the collection system 276. As discussed above, the collection system 276 can be configured to collect the slices after cutting, and can lead to a dewatering system, etc. With this system, selecting between the different cutting machines 272 is fast, and product damage can be reduced or avoided by selecting large radius elbows 274 in the product transport extension conduits 270. Conduits can also be relocated to form the flow paths and valves omitted. For example, the flow paths can be assembled as needed from pipe components and quick connectors without the need for valves. This option can help reduce the risk of product damage due to contact with the internal components of valves.

The system and method disclosed herein provides a cutter that is capable of producing slices and chips with single or compound curves in various configurations. It can be used for a variety of food products, such as potatoes, vegetables, cheese and other products. It is also believed that extruded food products, such as sausage, confections, etc., can also be fed into the cutter disclosed herein. The cutting of potatoes is considered to be one of the most likely uses for this device. By virtue of its configuration, the cup cutter can produce spherical section potato slices and chips, for example. Such cuts can be useful for dipping and as bases for condiments. It can also cut cylindrical and conical shapes, and a variety of other shapes are possible using this cutter.

This cup cutter produces three dimensional shapes by using a cutting head that is roughly cylindrical, having the shape of a drum rather than a wheel. Variations in the shape and curvature of the cut slices can be selected by varying the curvature, angle and other geometric characteristics of the cutting blades. To reduce friction as the blades cut through the product, the blades can be curved along their long axis so that the trailing edge of the blade directly follows the cutting edge through the food product. The blades can also be corrugated to product crinkle or ridged cuts.

It is to be understood that the above-referenced arrangements are illustrative of the application of the principles of the present invention. It will be apparent to those of ordinary skill in the art that numerous modifications can be made without departing from the principles and concepts of the invention as set forth in the claims.

What is claimed is:

1. A cutting head for a food product cutting system, comprising:
a generally cylindrical rotatable body, having a radius, configured to rotate about an axis;
a plurality of spatially separated, generally parallel elongate cutting blades, arranged in a circular array centered on the axis and defining a perimeter of the body, each blade having a long dimension and an outwardly-oriented cutting edge;
wherein the generally cylindrical rotatable body is connectable to a driving mechanism configured to rotate the cutting head about the axis, and is positionable adjacent to a food product delivery mechanism, whereby food product that contacts the cutting edges of the array of blades in a direction generally perpendicular to the axis is cut by the blades into slices having a repeatable curvature.

2. A cutting head in accordance with claim 1, further comprising:
a top plate;
a bottom annular rim, each of the cutting blades having a top end attached to the top plate and a bottom end attached to the annular rim, the array of blades defining an interior of the cutting head, and the annular rim defining a discharge opening communicating with the interior and substantially aligned with the axis.

3. A cutting head in accordance with claim 1, wherein the array of cutting blades area arranged in one of a strictly cylindrical array, a conical array, and a truncated spherical array.

4. A cutting head in accordance with claim 1, wherein the cutting blades have a geometric shape selected to produce slices having one of a radial curvature, a conical curvature and spherical curvature.

5. A cutting head in accordance with claim 1, wherein the cutting blades are curved about a transverse axis thereof, whereby the food product is cut by the blades into slices having a double curvature.

6. A cutting head in accordance with claim 1, wherein the cutting blades are curved about a longitudinal axis thereof, each blade having a radius of curvature at a given point along the blade that is approximately equal to a radius of the curved path of the blade through the food product at the given point.

7. A cutting head in accordance with claim 1, wherein the rotational axis is substantially vertical.

8. A cutting head in accordance with claim 1, wherein the cutting blades have a generally corrugated cutting edge, configured to produce cut slices having ridges.

9. A food product cutting system, comprising:
a motor, having a rotatable drive shaft downwardly oriented along a substantially vertical axis;
a generally cylindrical cutting head, attached at a distal end of the drive shaft, having a radius and including a plurality of generally upright blades, symmetrically disposed about the vertical axis and having outwardly-oriented cutting edges, the blades defining an inside and an outside of the drum and a lower discharge opening; and
a food product delivery device, configured to advance food product laterally against the blades of the rotating cutting head, whereby the product is cut into slices having a repeatable curvature, the slices dropping through the discharge opening after cutting.

10. A system in accordance with claim 9, wherein the plurality of cutting blades area arranged in one of a cylindrical array, a conical array, and a truncated spherical array.

11. A system in accordance with claim 9, wherein the slices have one of a radial curvature, a conical curvature and a spherical curvature.

12. A system in accordance with claim 9, wherein the cutting blades are curved about a transverse axis thereof, whereby the food product is cut by the blades into slices having a double curvature.

13. A system in accordance with claim 9, wherein the cutting blades are curved about a longitudinal axis thereof, each blade having a radius of curvature at a given point along the blade that is approximately equal to a radius of the curved path of the blade through the food product at the given point.

14. A system in accordance with claim 9, wherein the cutting blades have a generally corrugated cutting edge, configured to produce cut slices having ridges.

15. A system in accordance with claim 9, wherein the food product delivery device comprises a water knife pump.

16. A system in accordance with claim 9, wherein the food product delivery device is configured to advance the food product against the rotating cutting head at an advancement speed, such that the repeatable curvature of the slices is determined by the advancement speed and the radius of the cutting head.

17. A method for cutting a food product, comprising:
rotating a generally cylindrical cutting head about an axis, the cutting head having a radius and an array of blades spatially separated blades symmetrically disposed about the axis, the blades having outwardly-oriented cutting edges; and
advancing a food product against the rotating cutting head in a direction generally perpendicular to the axis, whereby the food product is cut by the blades into slices having a repeatable curvature.

18. A method in accordance with claim 17, wherein rotating the generally cylindrical cutting head comprises rotating a cutting head having blades defining one of a cylindrical array, a frusto-conical array and a truncated spherical array.

19. A method in accordance with claim 17, wherein rotating the generally cylindrical cutting head comprises rotating a cutting head having blades that are curved about a transverse axis thereof, whereby the food product is cut by the blades into slices having a double curvature.

20. A method in accordance with claim 17, wherein advancing the food product against the rotating cutting head comprises advancing the product at an advancement speed, the repeatable curvature of the slices being dependent upon the radius of the cutting head and the advancement speed.
